(19) United States
(12) Patent Application Publication
(10) Pub. No.: US 2025/0004430 A1
(43) Pub. Date: Jan. 2, 2025

(54) Automated Neural Network Architecture for Constrained Industrial Applications

(71) Applicant: AspenTech Corporation, Bedford, MA (US)

(72) Inventors: Heiko Claussen, Wayland, MA (US); Demetris Lappas, Waterbury, CT (US); Alireza Karimi, Marlborough, MA (US); Xiaozhou Zou, Woburn, MA (US)

(21) Appl. No.: 18/345,227

(22) Filed: Jun. 30, 2023

(51) Int. Cl. G05B 13/02; G05B 13/04

(52) U.S. Cl. CPC G05B 13/027; G05B 13/048

(57) ABSTRACT

Processor system, apparatus and method generate improved model of an industrial or chemical process. A multiple input variable multiple output variable (MIMO) model of a subject industrial process is translated into a custom modified neural network. The custom model is modular (componentized) and is formed of plural multiple input single output (MISO) models. Each MISO model represents a respective input variable-output variable relationship of a subset of the input variables and associated one output variable of the initial MIMO model. The plural MISO models enable modeling relatively simple input variable-output variable relationships with a minimal number of parameters while modeling other input variable-output variable relationships with relatively complex representation on an as need basis. Architecture of each MISO model is automatically assigned. The architecture is optimally selected from a library of machine learning or neural network basis model architectures.

### BACKGROUND

In a broad set of applications like design optimization of capital-intensive equipment, supply planning, scheduling, advanced process control etc. it is critical to model the behavior of the equipment or environment. The models can be used in “what if” simulations and inform a design process on the best configuration, models can predict demand and thus help optimize inventory, or models can inform an advanced process controller on the direction that control variables need to be adjusted to achieve a more favorable regime of operation. The quality of the model is critical in these applications as errors in the design and operation of such capital-intensive equipment can result in large economic loss, environmental hazards or even in loss of life.

Traditionally, such models have been limited to first principles equations that ensure a very predictable and explainable behavior even for previously unobserved operational regimes. However, such first principles-based models cannot account for all physical effects and therefore sometimes fall short in accurately representing the behavior of equipment in the field. Examples include long term aging effects such as fouling of heat exchangers or corrosion. Given that capital intensive processes generally have very large product value flows, even small improvements have significant impact on the profit. Given the complexity to accurately model the real-world process with first principles models, the required expertise and time can be prohibitive in some applications. Also, first principles models can be very computationally expensive to solve. This can prevent other valuable use cases e.g., in real-time control or when large input spaces need to be explored.

Given these constraints of traditional modelling, there has been a rise of machine learning models to close this gap. Machine learning models can represent complex, nonlinear behavior, can model custom effects based on actual plant data, are relatively easy and fast to create, and have strong computational performance. Challenges of data driven models are that they generally only work well in the operational regimes where training data has been available. Given that capital intensive processes are often operated in a narrow regime, this is problematic when requirements change e.g., as seen in demand changes during COVID. Also, while neural networks are general function approximators and can accurately model highly nonlinear behavior, they are generally overparametrized. That is, neural networks often have a larger number of parameters than available number of training samples. This can lead to overfitting and unexpected behavior in not tested input configurations. For example, the neural network could be trained on smooth data in an input range [0-100] and result in smooth outputs in the range [0-16] and [20-100] but have erratic outliers in the range [16-20]. While this is generally not the case and overfitting is discouraged by engineering approaches like early stopping of the training process or random dropout processes of the trained weights, there is no formal proof towards a controlled neural network behavior. While the results of neural network models are often favorable, this uncertainty is problematic in use cases with significant consequences of false predictions.

Another challenge of particularly so-called black box models (that don't allow interpretability of how the result was achieved) is that they limit the ability of a user to interpret the current state to intervene in case of an issue. For example, if an equipment in a chemical plant is approaching dangerous operational conditions, e.g., over pressure, and all parameters are set by a black box model, the operator cannot easily conclude the root cause and intervene. On the other hand, if the model is first principles based, it would be possible to understand the root cause of the dangerous situation and to address e.g., upstream conditions or settings.

Other reasons why data-based models are not easily trusted is if they use inputs to infer outputs that have no physical relationship to the modelled process. For example, if two processes are affected by a change in overall plant settings that resulted in multiple parameter changes at the same time, all parameter changes are correlated with an effect on both processes. However, some of the parameter changes may only affect behavior in one of the processes. While this causality is not visible in the training data, building a model that assumes relationships that are physically not there is detrimental for the robustness of future model results. Therefore, there is a need for machine learning models in asset intensive industries to encapsulate physics like input/output causality.

### SUMMARY

Embodiments of the present invention provide a system, method, and an approach to automatically, not only train the weights of a neural network, but to architect a custom model based on the use case requirements to:
Enable modelling of complex nonlinearities
Minimize complexity to increase robustness
Enable models that extrapolate well for unknown data
Enable overall constraints e.g., mass balance
Enable input-output sensitivity curves for interpretability and derivatives
Physically constrain input-output relationships

According to Applicants, the solution to the foregoing problems in the art comprise the following four aspects:

a) The model representation is selected to be a custom modified neural network. The concepts of the present invention can however also be applied to other model types as well as hybrid approaches. The reason is that neural networks are at the limit general function approximators. That is, neural networks can represent any function and only need to be modified to address the inherent issues such as overparameterization, missing interpretability, missing formal constraints (e.g., input-output dependency) etc. Also, there are many software and hardware advances available to neural networks that allow for efficient training and inference (e.g., GPU acceleration) and portability to different software packages and solvers (e.g., TensorFlow, Julia). That is, the model of interest is treated as just a neural network with complex internal structure (various activation functions, sparse custom connections etc.).

b) While complex equipment models, that are the target of embodiments of the present invention, generally have multiple inputs and multiple outputs (MIMO), Applicants take a divide and conquer approach and split target models into a combination of multiple models that have multiple inputs and a single output (MISO). This allows for description of input-output sensitivities. That is, every output is independent of other output models and has a defined dependency on a subset of inputs. Also, in this way it is easy to constrain input-output dependencies as every MISO model can have a different subset of inputs. Another advantage of this approach is it enables a stratified train/test split for each output variable. A stratified split is helpful when the distribution of a variable is complex, where a random split may result in very different distributions in training data and testing data. When training data and testing data have rather different data distributions, the model built from the training data set will have a bad performance on the testing data set, leading to a misinterpretation that the model is not usable. Generally, such an approach has the disadvantage that it significantly increases the number of parameters by an order as defined by the number of outputs and requires a further reconciliation layer. However, as not all input-output relationships are complex and not all outputs are dependent on all inputs, this decomposition allows to model simple (e.g., linear) relationships with minimal parameters and only as needed requires complex representations (increased number of parameters and reconciliation layer(s) in the neural network).

c) The goal of the present invention is to automatically customize the architecture of the target model. Given that a neural network of required complexity for relevant industrial applications has a large number of parameters and it is a combinatorial problem to assign custom connectivity and activation functions, a brute force approach is not possible. Therefore, Applicants define a small set of basis model architectures (e.g., three) and automatically assign them to the respective input-output relationships. A reluctant approach should be taken to use the minimally complex model that represents the behavior. For example, first the simplest basis model is assigned to all input-output relationships, the system is trained and evaluated. In a next step, a more complex basis model is selected for input-output relationships that were performing poorly on the simpler model. This approach is continued until all basis models are appropriately assigned with minimal complexity. This resultantly minimizes the overall (total number of) parameters within the target model. Also, the simple basis model functions can be selected to have specific behavior. For example, a basis model function can be a single neuron with linear activation function thus enforcing a linear input variable-output variable relationship. Also, by this basis model function behaving linearly (enforcing linear input variable-output variable relationships), the input variable-output variable relationship is guaranteed to extrapolate linearly outside of the training range. Similarly, a basis model can be selected that limits the input variable-output variable relationship to smooth functions (e.g., no or free of discontinuities). This behavior is favorable for control applications. Finally, a more complex neural network basis model (e.g., a multi-layer, fully connected neural network) is enabled to represent input-output relationships that require complex nonlinear behavior.

d) Finally, a reconciliation layer is added to the end of the multiple MISO structure to ensure that overall constraints are fulfilled e.g., mass balances or component balances, for non-limiting example. This reconciliation layer is connected to both the original inputs and the predicted outputs of the multiple MISO structure.

In embodiments, a computer implemented method of modeling an industrial or chemical process, comprises the steps of:
obtaining a subject model of an industrial process, the subject model being formed of plural multiple input single output (MISO) models, each MISO model describing or representing a respective input variable-output variable relationship (dependency) of a subset of input variables and associated one output variable of the subject model, and different MISO models representing a different one of the output variables of the subject model, wherein the plural MISO models enable: (a) stratified distribution of training data and test data for each output variable, and (b) modeling relatively simple input variable-output variable relationships with a minimal number of parameters while modeling other input variable-output variable relationships with relatively complex representation on an as need basis;
for each MISO model, automatically assigning a basis model architecture of minimal complexity that enforces the respective input variable-output variable relationship (dependency) of the MISO model; and using the plural MISO models with assigned architecture, forming a customized machine learning architecture for the subject model.

The forming of the customized architecture results in an improved model of the industrial process. The customized machine learning architecture may be a neural network or the like.

The subject model may be obtained by:
accessing a model representing the subject industrial process, the accessed model having multiple input variables and multiple output variables (MIMO); and
splitting the accessed model into the plural MISO models, the plural MISO models collectively being equivalent to the accessed MIMO model.

The method further includes coupling the plural MISO models with assigned architecture to a reconciliation layer. The reconciliation layer is configured to receive: (i) values of the multiple input variables, and (ii) values of the output variables of the plural MISO models, and the reconciliation layer ensures adherence to constraints of the industrial process.

The industrial process represented by the subject model may be any of: a chemical process, processing of a pharmaceutical, petroleum processing or part thereof, a subsurface engineering process, digital grid management, a mining domain process, or other process modeled in engineering or physical sciences, and the like.

The automatic assigning a basis model architecture includes: (a) initially assigning a linear basis model architecture to each MISO model; and (b) training and evaluating performance of the MISO models, for a MISO model having the respective input variable-output variable relationship performing poorly using the assigned linear basis model architecture, revising assignment to a more complex basis model architecture relative to the linear basis model architecture.

In embodiments, when a given MISO model has or represents a respective input variable-output variable relationship that is a linear function, the automatic assigning for the given MISO model assigns a basis model architecture that has a linear activation function and thus enforces linear input variable-output variable relationships.

In embodiments, when a given MISO model has or represents a respective input variable-output variable relationship that is a smooth function (free of discontinuities), the automatic assigning for the given MISO model assigns a basis model architecture that has a smooth activation function and thus enforces smooth, free of discontinuities input variable-output variable relationships.

In embodiments, said automatic assigning results in minimizing overall number of parameters in the formed customized machine learning architecture and thus in the resulting improved model.

In runtime of the resulting improved model, the reconciliation layer refrains from modifying predictions from a MISO model with assigned basis model architecture that extrapolates well and instead corrects predictions from one or more MISO models with assigned basis model architecture that is unreliable for extrapolation.

In embodiments, the automatic assigning a basis model architecture for a given MISO model includes searching a library of basis models for a best basis model architecture for the one output of the given MISO model. The searching of the library is performed as a function of any one or more of: (a) user-specified input variable-output variable relationships, (b) user-specified constraint of the subject industrial plant process, and (c) user-specified properties for the one output of the given MISO model.

Other embodiments include computer program products, computer-based systems, and computer apparatus performing or implementing the steps of the above (and herein described) method of modeling an industrial process or chemical process, a subsurface engineering process, digital grid management, a mining domain process, and the like.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a schematic illustration of a fully connected neural network with hidden layers and sigmoid activation functions in embodiments.

FIG. 2 is a schematic illustration of a componentized multi-MISO neural network with various activation functions in embodiments. The reconciliation layer is part of the overall network structure and ensures adherence to physics-based constraints and chemistry-based constraints of the industrial/chemical plant process being modeled.

FIG. 3 is a graph comparing: (i) the number of trainable parameters for a neural network only using the nonlinear basis models, with (ii) the number of trainable parameters for a neural network using both linear and nonlinear basis models in embodiments.

FIG. 4 is a graph showing R² scores of various dependent variables for the test dataset based on the prediction of a neural network utilizing both linear and nonlinear basis models (NN1) in embodiments vs a neural network employing only nonlinear basis models (NN2).

FIG. 5 is a flowchart illustrating the method employed by embodiments to automatically create and train a modular constrained neural network with defined output properties and minimal complexity.

FIG. 6 is a schematic view of a computer network in which embodiments are deployed.

FIG. 7 is a block diagram of a computer node in the computer network of FIG. 6.

FIG. 8 is a block diagram of a process control, simulation, and/or optimization method and system embodying the present invention, for non-limiting example.

### DETAILED DESCRIPTION

A description of example embodiments follows.

There are many approaches to address different modelling challenges for asset intensive industries. In the following, the advantages of the proposed automatic neural network architecture are discussed over four prominent solutions:

### a) First Principles Models

As discussed above, a significant disadvantage of first principles models is the expertise and time needed to build them. Also, the computational effort to run first principles models limits their application in various use cases such as real-time control or exploration of large input domains. Moreover, first principles models are not accounting for all physical phenomena (e.g., fouling or corrosion) or unobserved asset dependent differences (e.g., sensor bias, difference between built and design specification, uncertainty in feedstock etc.). In contrast, Applicants' proposed modelling approach uses real data from the field to automatically model a custom representation of the asset. On the one side, this limits the expertise and time necessary to build the model. On the other side, the model can represent the full behavior of the specific asset given that the real data explicitly represents the behavior of the asset. Finally, given the neural network-based nature of the approach, inference of the model is fast and can be further accelerated by GPUs or specific ASICs that have become more common due to the broad adoption of neural network use cases in other domains (e.g., smart cameras, drones, driver assistance etc.).

### b) First Principles-Based Hybrid Models

Building on first principles but adapting the parameterization based on real world asset data is the strength of first principles-based hybrid models. These models ensure interpretability, meaningful extrapolation, where no data is present, but also better represent the asset behavior where data is present than pure first principles models. Rather than building on an arbitrary hand-crafted kernel function (as linear or piecewise linear models discussed below), first principles-based hybrid models use the more complex first principles relationships of the process. For modelling unknown or uncertain input parameters, one can use complex black box models like neural networks without affecting the interpretability or proven first principal model behavior. However, disadvantages of this approach are similar to the pure first principal models. That is, the first principles are challenging and time consuming to model and the computational performance is limiting in some applications. Also, not all physical effects are represented in a first principles model. That is, the model is not only having uncertainty in the parameterization but also itself does not represent all physical effects. The parameters are trained based on data from the field to best fit the real behavior but given the mismatch between the model and the full physical effects, an exact match is not possible. In contrast, the proposed automatic neural network architecture is not requiring the definition of a first principles model. Therefore, it can be created with less experience and time. Also, its inference performance is computationally outperforming first principle-based approaches. Finally, the model is not a priori constrained by our understanding of the underlying physical behavior but only tries to mirror the behavior observed in the data of this specific asset. As a result, this approach has the capability to outperform the first principles-based hybrid models within the training range.

### c) Linear or Piecewise Linear Models

A common attempt to build simplified models that computationally perform well but also have defined properties (e.g., extrapolation, gain etc.) is to linearize the asset behavior. For nonlinear input-output relationships one approach is to use piecewise linear models. Alternatively, nonlinear relationships can be represented by a kernel trick. That is, the inputs are transformed by a nonlinear kernel function and the model is assumed to be linear in this projected space. Disadvantages of this approach are its challenges for nonlinear input-output relationships. That is, the simple linear model is not able to capture nonlinear behavior and it is hard to find a custom kernel for each application that linearizes the input-output dependency. Generally, the kernel needs to be manually selected and still has some mismatch with the real-world data resulting in inaccuracies of the resulting model. Finally, the piecewise linear model results in discontinuities that result in issues for control and optimization applications that are often relying on smooth derivatives to find the global optimum. In contrast, the proposed method can both model linear and nonlinear behavior without requiring a manual selection of a kernel function. Also, embodiments consider constraints (e.g., mass balance and component balances) that are critical for models aimed for design applications. Therefore, the proposed modelling approach generalizes better for a broader set of applications.

### d) Symbolic Regression

Symbolic regression builds a model by searching a large space of mathematical expressions to find a combination that best fits a given data set. The base function space consists of common transformations such as linear, polynomial, exponential, reciprocal, etc. This approach stands out in interpretability because all parts of the model are known, well-understood functions. Another advantage of this approach is that the behavior of the model could be controlled by manipulating the base function space. For example, by limiting the function space to smooth functions, one could guarantee smoothness of the resulting model. However, since base functions could be combined in numerous ways, searching for the best combination is extremely time-consuming. This issue worsens as the problem scales up. In an asset intensive industry where a problem could have hundreds of input variables, it is impossible to fully search all combinations to locate the globally optimal model. In practice, heuristic approaches like a genetic algorithm or Bayesian methods are used to discover a satisfactory model within a reasonable amount of time. Due to the heuristic nature, the resulting model is usually less accurate than one generated by optimization, as used in embodiments of the present invention. Furthermore, the multi-MISO structure in embodiments independently models the dependencies between input variables and output variables, thus closing the gap in interpretability.

### c) Constraints in Cost Function (e.g., PINN)

In machine learning it is often the goal to identify a model that best represents the data as defined by a cost function. In the simplest cases, this cost function aims to minimize the squared difference between the model predictions and the observed asset data. However, in many applications, there are other factors to consider e.g., constraints. It is common that these constraints are added with a Lagrangian multiplier to the cost function. That is, any violation of the constraint is significantly penalized such that this solution can no longer have a cost that is considered a suitable result to the problem. A similar approach is taken for physics informed neural networks. Here, first principles models are used in the cost function for training a model to ensure that the training adheres not only to the data but also to the underlying physics. While these approaches show impressive results even for ranges where no training data is available, they do not formally enforce the constraints during inference. That is, after training, a model is provided that was validated not to significantly violate the constraints. However, during use of the model, the cost function is no longer considered so not tested input configurations could potentially significantly violate the constraints. Also, this approach balances the constraints with other goals of the modelling such as finding a good model fit. That is, a small violation of constraints is accepted if the overall solution provides a good result. In asset intensive industries it is often not acceptable if there is some minor violation of constraints and it is expected that there is a formal proof that constraints cannot be violated (e.g., no mass can be created from nothing). Such formal proof is generally only possible if the constraint is encoded within the model itself. Given the combinatorial complexity of building a neural network model with custom numbers of neurons, connections, weights, and activation functions, it is common practice to engineer the model architecture from experience and optimize experimentally.

In contrast, Applicant's approach first simplifies the problem by transferring MIMO into MISO structures and then automatically composes the model in a custom way to fit the use case; but limits the components to a set of defined basis models to limit the combinatorial nature of the problem. The basis models are selected to have favorable properties for the domain and are of minimal complexity to enable defined extrapolation behavior. This minimized number of parameters is resulting in favorable robustness over a standard neural network architecture design process. The reconciliation layer formally enforces constraints, is connected to the inputs and outputs of the MISO models and remains with the trained model also during inference, to ensure the constraints continue to be enforced. Applicant's approach does not limit other extensions such as PINN motivated cost functions for training and better operation in ranges where no training data is available. Applicants choose not to require this step as the physics informed cost function design again requires expert knowledge and significant effort and therefore limits advantages for some applications.

As mentioned above, Applicants aim to create a flexible hybrid modeling approach that adapts to the problem at hand, can represent both linear and nonlinear input/output relationships in an efficient manner, allows for exact/formal constraints (e.g., mass balance, component balance, defined input/output relationships), enriches interpretability, can guarantee extrapolation behavior at least for some input/output relationships, and minimizes internal parameterization to avoid overfitting and require minimal amount of training data.

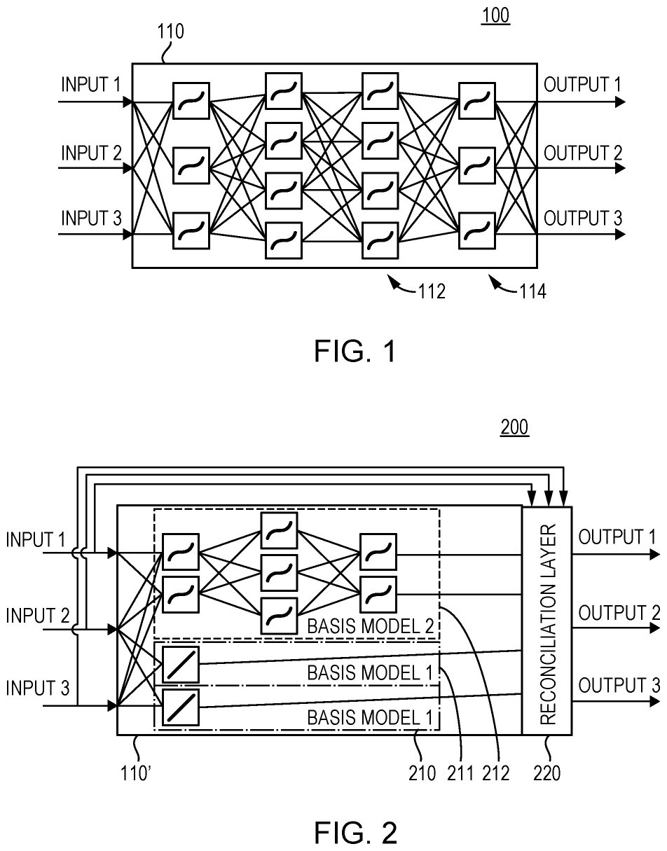

Generally, neural network architectures are hand crafted by experience and trial and error experiments. Thereafter, data scientists are just reusing successful architectures (e.g., AlexNet, SqueezeNet, ResNet etc.), often even leaving most of the pretrained parameters intact and only adapting the last fully connected layers to a new problem. The new problem is specified by adjusting the cost function of the problem. The advantage of this approach is that less training data, limited expertise on neural network architectures and less experimentation effort is needed. Alternatively, for non-image data-based regression or classification, it is common to use relatively shallow, fully connected architectures with sigmoid activation functions as shown in FIG. 1. There have been many attempts to automatically create more formally optimal neural network architectures from data using e.g., reinforcement learning or genetic algorithms. This research field called “Neural Architecture Search” has recently produced some interesting results (e.g., AutoML-Zero), but the complexity of the task is so vast that research is still very early and only very small architectures can be created.

One of the challenges of neural networks is the large number of parameters needed for deep architectures. Training many parameters requires a lot of data and other tricks (e.g., early stopping of the training, random dropouts, architectural constraints) to avoid overfitting. One aspect why these commonly random approaches work is that there is some sparsity in the optimal representation. That is, only some paths need the full depth of the model and pruning other paths early on has no negative impact on the result. The reason that random approaches are preferred is the large complexity of neural networks. That is, as shown in the Neural Architecture Search research, it is currently not possible/tractable to detect formally, which connections, activation functions, and layer types are best for a specific problem.

FIG. 1 is an illustration of a fully connected neural network 110 with hidden layers and sigmoid activation functions.

Rather than using a fully data driven approach to identify a sparse internal structure of the neural network 110, embodiments use domain know-how to limit this search space. Applicant's approach is motivated by the intuition that the simplest model that has the desired behavior (e.g., linear extrapolation, smooth derivatives, constraints to simplified first principles etc.) and suitably fits the training data (e.g., R\hat{ }2>95% or similar) is “optimal” for the use case. To enable this sparse hybrid representation (both data and domain knowledge based) of each input variable/output variable relationship, it is necessary to disentangle the neural network 110. When using a fully connected multiple input multiple output (MIMO) structure as in FIG. 1, the only differentiation between the outputs is in the very last layer 114 of the network. That is, simplifying any structure before would potentially affect all outputs (if the related weight is not zero and the simplification changes any behavior). Also, the features at the second to last layer (penultimate layer) 112 must be so generic that they can be used to predict any of the outputs by only using one transformation layer (i.e., weight for each output from the earlier layer plus one activation function). By disentangling the network in a straightforward manner, i.e., creating multiple, equivalent multiple input single output (MISO) structures, each output gains more flexibility in the way features are extracted for its prediction/classification tasks. However, this approach significantly increases the parameters of the model 100 by an order of the number of outputs. For the simple model 100 in FIG. 1, there are currently 58 weights (one weight for each connection). The conceptually straight forward translation to a multiple MISO model would result in 150 weights, thus further amplifying the overparameterization related issues of the neural network 110.

However, as indicated before, this disentanglement enables a divide and conquer approach by allowing to simplify the respective network structures independently. Also, it allows customization of functional behavior of the respective input variable/output variable relationship. For example, output 1 can enforce a linear dependency to the inputs while output 2 can allow for a complex nonlinear behavior (function or relationship between input variables and output variables). Moreover, it is now easy to prevent non-physically meaningful contributions from some inputs to some outputs i.e., by just not connecting them for a specific output channel. However, while the modeling is with this multiple MISO structure more flexible, it is still not clear which sub structures (model architectures) to use. Also, the overall outputs cannot be fully independent as they must fulfill constraints (physics-based and chemistry-based) jointly e.g., uphold mass balance.

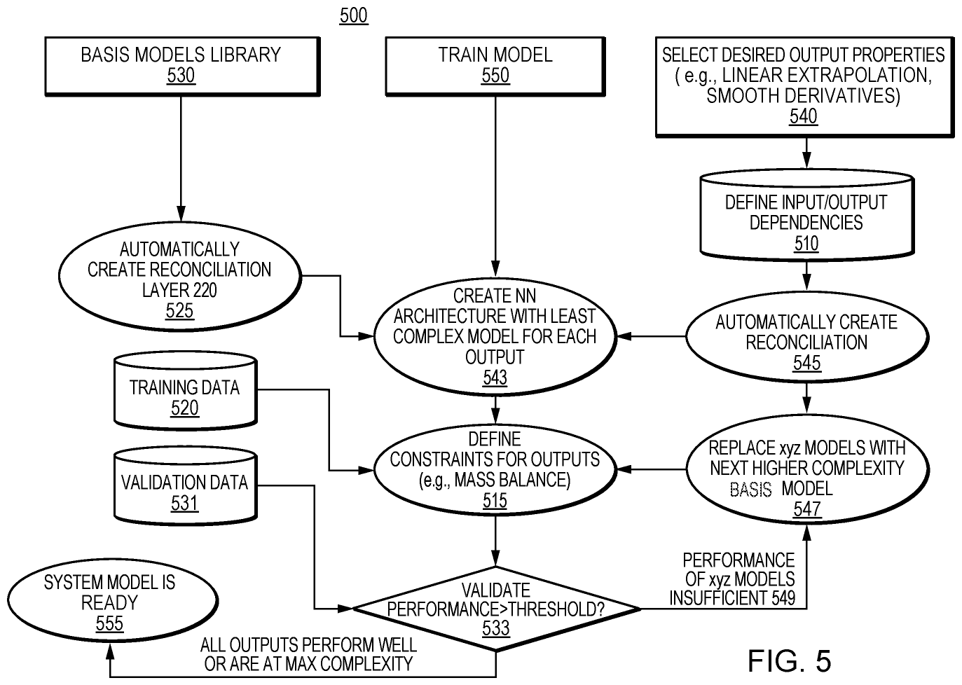

Embodiments of the invention therefore propose to componentize the neural network 110 architecture in a set of “Basis Model” Architectures 210, 211, 212 from a library 530 (FIG. 5) and append (or otherwise effectively utilize) a reconciliation layer 220. FIG. 2 illustrates a non-limiting example of the architecture for the multiple MISO system or model 200. All of the inputs (Input 1, Input 2, Input 3) of system model 200 are the same or of the same value as those of model 100 (FIG. 1). Each of the outputs (Output 1, Output 2, Output 3) of system model 200 are of equivalent value to the counterpart output of model 100. The reconciliation layer 220 is configured to receive: (i) the values of the multiple input variables (Input 1, Input 2, Input 3), and (ii) the values of the output variables of model 200. The illustrated architecture uses “Basis Model 2” 212 to model system Output 1 before reconciliation and uses “Basis Model 1” (at 210, 211) to model system Outputs 2 and 3 before reconciliation. It is noted there is exactly one system model 200 output (Output 1, Output 2, or Output 3), i.e., the output represented by a subject MISO of the multiple MISOs, per respective basis model architecture (the architecture used to implement the subject MISO). It must also be noted that while Outputs 2 and 3 are based on the same basis model architecture type, they are separately trained and therefore independent models 210, 211 implementing respective MISOs. This modular customization allows for sparse representations even in the multiple MISO setting that usually amplifies overparameterization. For the example in system model 200 in FIG. 2, only 28 weights are used, which compares favorably to the fully connected example system model 100 in FIG. 1 with 58 weights.

To give an intuition why this reduced number of weights is possible for the same output accuracy it is important to note that only the first output has a nonlinear relationship with the inputs. If the model needs to provide a linear and nonlinear output based on the same features in the second to last neural network layer 112 in FIG. 1, then either the last layer 114 of the linear outputs has to linearize the nonlinear feature dependency from the second to last layer 112, or the nonlinear output needs to model the nonlinearity with only one final layer, or part of the features in the second to last layer 112 represent linear and the others nonlinear relationships and they are used respectively by the outputs. All these options are inefficient and the first two options require an additional layer in the network 110.

FIG. 2 is an illustration of a componentized multi-MISO neural network 110′ (of example model or system 200) with various activation functions. The reconciliation layer 220 is part of the overall system network structure and ensures adherence to constraints (physics-based constraints and chemistry-based constraints of the industrial/chemical process being modeled by system (model) 200).

The reconciliation layer 220 is necessarily independent of the underlying network 110′ architecture to ensure formal adherence to constraints (physics-based, chemistry-based, etc.). For example, the sum of the mass of all system input flows needs to exactly equal the sum of mass of all system output flows. This approach re-introduces dependency between all output predictions even for Applicant's multiple MISO approach, given that mass balance may not exactly be upheld before the reconciliation layer 220, and it requires balancing. However, the reconciliation layer 220 is included both for training of the network 110′ and for runtime operation. Therefore, global constraints like mass balance are always ensured. Given that some model types (e.g., fully connected deep neural networks that could be necessary to model complex nonlinearities) are not stable when extrapolating in areas where no training data is present, the reconciliation approach can detect regimes outside of the training range and bias towards predictions from stable (e.g., linear) basis models if they are available. For example, if two basis models that extrapolate well and one that does not extrapolate well have a mass output and the runtime is in an unknown mode of operation then the reconciliation layer 220 will not modify the predictions from the basis models that extrapolate well but only correct the prediction of the Basis Model type that is known to be unreliable for extrapolation. That is, the domain knowledge of the properties/behavior of each Basis Model 210, 211, 212 are encoded and used to optimize the approach in the reconciliation layer 220 and to strengthen performance, interpretability, and explainability of the respective output behavior of system 200.

As indicated above, while one can define a set of Basis Models (architecture) 210, 211, 212 with different, favorable properties, it is not a priori clear which Basis Model architecture is best for a specific system output (Output1, Output2, Output3, . . . ) in a specific use case. Recall there is exactly one system model 200 output (Output1, Output2, Output3, . . . ), i.e., the output represented by a subject MISO of the multiple MISOs, per respective basis model architecture (the architecture used to implement the subject MISO). While it is preferable to have a simple basis model, it is necessary that the basis model performs well on the data at hand and has use case specific properties. There is not a one fits all basis model which is why some data scientists either oversimplify by biasing towards linear models and others hand customize which limits scalability, supportability, and interpretability. Applicant's invention proposes an automated best basis model (architecture) per MISO search process as illustrated in FIG. 5 (detailed below) to address this problem.

For the proposed approach, the user has the option to specify which inputs/output dependencies (i.e., relationships between system input variables and system output variables) exist in the use case, which (physics-based and/or chemistry-based) constraints of the subject processing plant/industrial or chemical process being modeled by system 200 need to be fulfilled, and if certain basis model behavior is desired. While none of the user specified inputs is of necessity (a requirement), they individually and in combinations help guide the automated search for a customized multi MISO neural network architecture 110′ that is fit for the use case as represented by the training data at hand and domain expertise on its behavior. Based on the user-defined constraints, the reconciliation layer 220 can be automatically generated. If no constraints are required, this layer 220 can be skipped. Based on the user-defined input variable/output variable relationships and dependencies, the respective Basis Models 210, 211, 212 can be connected to the system model 200 inputs (Input1, Input 2, Input3). If no input variable/output variable dependencies are specified by the user, the baseline is that all system model 200 inputs (Input 1, Input2, Input3) are considered in every Basis Model 210, 211, 212, i.e., MISO of the neural network 110′. Finally, the desired and required basis model properties are specified by the user for each basis model output/corresponding MISO output/system output e.g., for non-limiting example, the basis model needs to have smooth derivatives or needs to enforce a non-linear function representative of the MISO input variable/output variable relationship, etc. As only a subset of all defined Basis Models (architecture) in the library 530 has this property, only the pertinent subset of the candidate basis models (architecture) is considered for the output (basis model output/corresponding MISO output/system 200 output). If no preference is given by the user, then all Basis Models candidates in library 530 are considered. In embodiments, the Basis Models in the library 530 are ordered by preference. That is, lower complexity candidate basis models (architecture) are favored, candidate models (architecture) that extrapolate well are favored, candidate models (architecture) with smooth derivatives are favored etc.

Next, an overall system model 200 architecture is created automatically using the simplest suitable (architecture) basis models available in the Basis Model library 530 and given the autogenerated reconciliation layer 220. This initial basis model architecture (multi MISO, neural network architecture 110′) is trained using the provided training data 520 (FIG. 5) of the use case. Thereafter, each output prediction by the MISO of a respective basis model is separately evaluated using the validation data 531 (FIG. 5). Any initial basis model generated system output (model prediction) that cannot suitably represent the validation data 531 is identified, e.g., by having a low R\hat{ }2 score or not modelling a nonlinear peak in the data like an over-cracking peak of a fluid catalytic converter. The results are stored, and these identified basis models are replaced by the basis model candidates (architecture) of next higher complexity in the Basis Model library 530. The approach (above steps and method) is repeated until either all identified suitable basis models candidates in the Basis Model library 530 are explored or suitable low complexity basis models (qualified working basis models) are identified. If none of the candidate Basis Models in library 530 results in the targeted quality sought, then Applicant's method selects a basis model candidate that has the highest performance. Alternatively, to the described heuristic approach, a formal binary optimization approach can be utilized for selecting the optimal combination of suitable Basis Models 210, 211, 212.

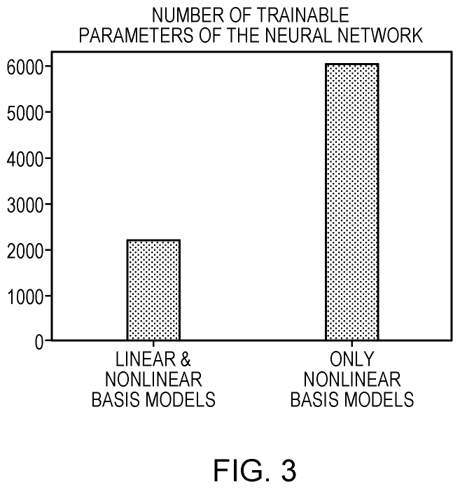

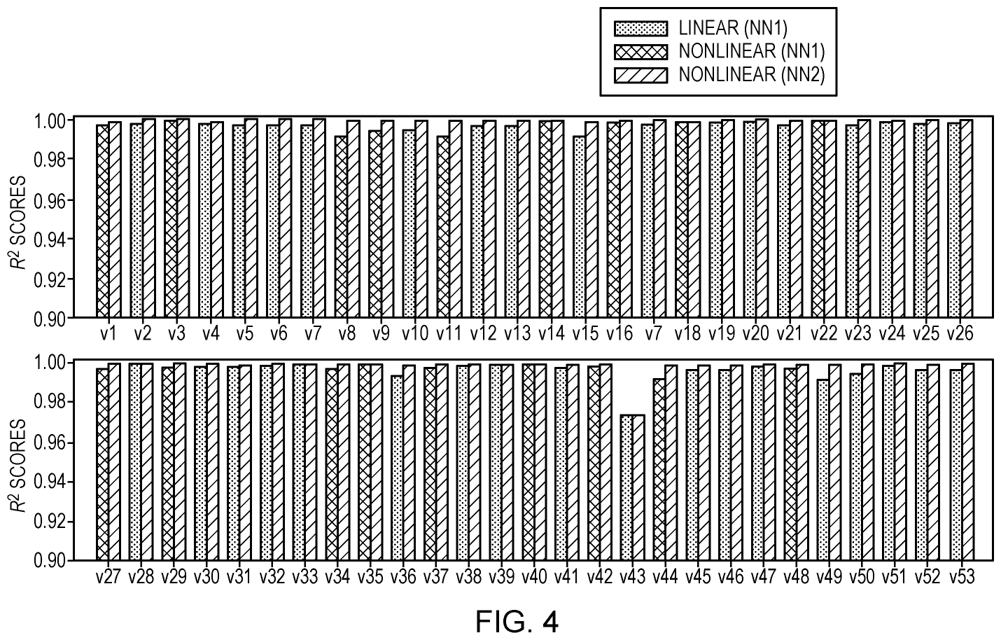

As will be made clearer below, FIG. 3 is a graph comparing the number of trainable parameters for a neural network 110 (FIG. 1) only using the nonlinear basis models with the number of trainable parameters for a neural network 110′ using both linear and nonlinear basis models 210, 211, 212. FIG. 4 is a graph showing R² scores of various dependent variables for the test dataset based on the prediction of a neural network 110′ utilizing both linear and nonlinear basis models (NN1) versus a neural network 110 (FIG. 1) employing only nonlinear basis models (NN2).

FIG. 5 is a flowchart illustrating in one embodiment the Method 500 to automatically create and train a modular constrained (multiple MISO) neural network 110′ with defined output properties and minimal complexity. The resulting neural network 110′ architecture supports or implements systems and models 200 modeling the behavior of industrial plant equipment or the behavior of a chemical processing environment (e.g., chemical reaction, petroleum refining, pharmaceutical processing) of interest such as in facility design optimization, supply planning, plant scheduling, advanced process may control, and other technology areas. Or, more generally, the resulting neural network 110′ architecture may implement models 200 representing any industrial process such as a subsurface engineering process, digital grid management, a mining domain process, or other process modeled in engineering, or physical sciences, for non-limiting example.

The Basis Model library 530 can include a large variety of model architectures that focus on different use cases. For purposes of illustration and not limitation, Applicants motivate and exemplify herein below a set of 4 Basis models (e.g., employable at 210, 211, 212 in system model 200). These are only meant as non-limiting examples and not an exhaustive list of basis model architectures (or architecture types):

1. Linear Model—Many input variable/output variable relationships can be modeled through linear dependencies. Given that this basis model architecture type is very simple, it only requires a minimal set of parameters and provides clear extrapolation capabilities. This type of basis model can be simply enabled in a neural network setting by a single layer neuron with linear activation function. The linear activation function enforces a linear input variable/output variable relationship (dependency).

2. Polynomial Model—Recently, there have been various papers proposing polynomial variants of neural networks. Some use polynomials as an activation function (e.g., to automatically optimize a parameterized activation), some others use quadratic neurons as another path to introduce nonlinearity and reduce the size/complexity of the neural network model. When limiting the depth of the neural network to one layer and utilizing a quadratic activation function, the neural network will be limited to a polynomial response of second degree. Therefore, while limiting prediction capabilities, there are guarantees regarding the smoothness of the derivative even for extrapolation behavior of the neural network. The polynomial activation function enforces a quadradic (or polynomial) input variable/output variable relationship (dependency).

3. Radial Basis Model—Another special type of a constrained neural network architecture are the radial basis function networks. These networks are only one layer deep and have a gaussian activation function. The center vectors of the radial basis functions are predefined e.g., by k-means clustering or support vectors of a support vector machine. This ensures easy interpretability of the result and defined extrapolation behavior e.g., the closest class for normalized radial basis functions. The gaussian activation function enforces a non-linear input variable/output variable relationship or dependency.

4. Fully Connected Model—It is valuable to have at least one basis model type in the library 530 that is a general function approximator. This ensures that even nonlinear input/output behavior (relationship between input variables and output variables) can be captured accurately. For this example, one can use a fully connected neural network with 3 neurons in the first layer, 4 neurons in the second layer and 3 neurons in the last layer.

In embodiments, the example basis models (the four listed above) are held as candidates in Basis Model library 530 and organized (or otherwise ordered) by preference. For a simplicity (lower complexity) preference, the Linear Model and Polynomial Model are favored, meaning prioritized, over Radial Basis Model and Fully Connected Model. For a preference of models that extrapolate well, the Linear Basis Model is favored (prioritized) over the other basis models. Where there is a preference for smooth derivatives the Polynomial Model is favored (prioritized) over the Radial Basis Model and the Fully Connected Model. And so forth.

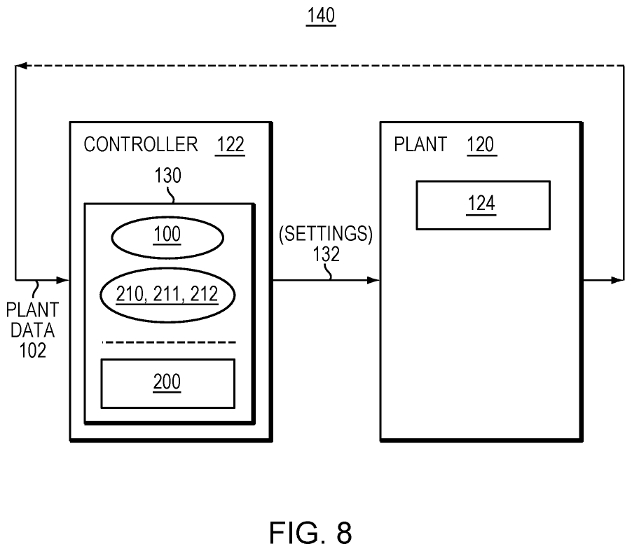

Method 500 begins with an initial fully connected, multiple input multiple output (MIMO), neural network architecture 110 (FIG. 1) that models an industrial process or chemical process (e.g., chemical reaction, for non-limiting example) 124 of interest at a real-world industrial environment/chemical processing plant 120 (FIG. 8).

Step 540 receives optional user input specifying certain system 200 output properties (i.e., corresponding MISO output properties/basis model architecture properties) representative of the desired overall system model behavior. For example, the user can specify that certain system outputs (Output 1, . . . . Output n FIG. 2) have smooth derivatives, another system output has a linear extrapolation, and other system outputs have complex nonlinearities representing a certain subset of input variable (Input 1, . . . , Input n)/output variable (Output 1, . . . . Output n) relationships. Other functional behavior of a respective input variable/output variable relationship can be user-specified at step 540.

The method at step 510 receives optional user input specifying: (i) relationships or dependencies between system input variables (Input 1, . . . . Input n in FIG. 1) and system output variables (Output 1, . . . , Output n in FIG. 1), and (ii) physics-based constraints and chemistry-based constraints that need to be fulfilled. In response, step 545 creates reconciliations that ensure adherence to the physics-based constraints and chemistry-based constraints.

Step 543 responsively splits, divides, or otherwise componentizes the initial neural network architecture 110 into multiple multi-input single output (MISO) structures that collectively is equivalent to neural network 110. Each MISO structure represents the relationship between a respective subset of system inputs (Input 1, . . . , Input n FIG. 1) and one output (Output 1 . . . , Output n FIG. 1). Different MISOs represent different subsets of system inputs (Input 1 . . . , Input n FIG. 1) and a different system output (Output 1 . . . , Output n FIG. 1). For a given MISO, the input variable/output variable relationship enforces a respective user-specified functional behavior received as input at step 540, and the given MISO output demonstrates (possesses) the corresponding property, i.e., smooth derivatives, linear dependencies, complex non-linear dependencies, etc. The so componentized or modular neural network 110′ of system model 200 results. The different MISO structures have different activation functions, and step 543 initially uses the simplest basis model architecture for each MISO (the Linear Model in the above example). In general, steps 543 and 547 (detailed later) select for a MISO architecture one of the basis models from basis model library 530, and in turn step 550 trains the MISO/assigned basis model architecture using training data 520 and including the reconciliation layer 220 in the training.

Continuing with FIG. 5, step 515 defines physics-based constraints and chemistry-based constraints for the respective input variables/output variables relationships. That is, in the respective user-specified input variable/output variable relationships of 510, these defined constraints individually adhere to rules of physics and chemistry, such as mass balance, energy conservation, and the like. Step 515 feeds these defined individual constraints to step 525 to create reconciliation layer 220 that ensures global (at system 200 output) adherence to physics-based constraints and chemistry-based constraints. Reconciliation layer 220 independently ensures formal adherence to all physics-based constraints and chemistry-based constraints so that the sum of mass, energy, etc. of all system input flows (Input 1, . . . , Input n FIG. 2) exactly equal the sum of mass, energy, etc. respectively of all system output flows (Output 1, . . . , Output n FIG. 2). Specifically, step 525 configures reconciliation layer 220 to rebalance any individual constraints initially defined by steps 545 and 515 in order to achieve global (system 200 output level) adherence.

At iterations in method 500, step 550 trains the modular constrained, multiple MISO, neural network architecture 110′ including appending the configured reconciliation layer 220 (from step 525) thereto. Individual MISOs, as configured upon method 500 selection of a corresponding basis model architecture, may be trained including the reconciliation layer 220 in the training. Known or common training techniques are employed using training data 520.

The sum of all the individual output predictions of the MISOs created at step 543 may not uphold rules of physics and chemistry, i.e., system level constraints discussed previously. Thus step 545 in turn rebalances the sum of all the MISO outputs resulting in a reconciliation that ensures global adherence to physics-based constraints and chemistry-based constraints. Specifically, where a subject MISO is not stable when extrapolating in areas lacking in the training data 520, the reconciliation step 545 detects regimes outside of the training range and biases towards predictions from stable basis models architectures available in basis model library 530 for the subject MISO. This is illustrated in FIG. 5 with step 545 looking at step 547. Such reconciliation as created by step 545 is fed to step 525, and step 525 responsively encodes or otherwise programs the same into reconciliation layer 220.

Continuing with the above example, say system model 200 is componentized to be formed of three MISOs, namely two of which are configured by respective linear basis models (architecture) 210, 211 that are known to extrapolate well and one of which is configured by a basis model (architecture) 212 that is known to not extrapolate well. After the componentized (modular) neural network 110′ architecture of system model 200 is trained based on training data 520 and including reconciliation layer 220, in runtime, the reconciliation layer 220 does not modify the predictions (outputs) from the two MISOs that extrapolate well and only corrects the predictions (outputs) from the MISO of the basis model 212 known to be unreliable for extrapolation. In this way, the domain knowledge of the properties and behavior of each basis model in library 530 (as exemplified in the four above listed basis models) are encoded in reconciliation layer 220 (at step 525) and used to optimize or at least improve system model 200 for runtime.

Now in a further example, let's say system model 200 is componentized to be formed of four MISOs. Two of the four MISOs (MISO 1 and MISO 2) are configured as before, by respective linear basis models (architecture) that are known to extrapolate well. MISO 3 and MISO 4 are configured by respective non-linear basis models (architecture) that are known to not extrapolate well. After the componentized (modular) neural network 110′ architecture of the system model 200 is trained based on training data 520 and including reconciliation layer 220, in run time, reconciliation layer 220 does not modify (i.e., withholds or refrains from modifying) the predictions or outputs from MISO 1 or MISO 2 that extrapolate well. However, reconciliation layer 220 corrects the predictions (outputs) from MISO 3 and MISO 4 of the basis models known to be unreliable for extrapolation. Specifically, reconciliation layer 220 projects the MISO 3 predictions and the MISO 4 predictions into the space of permitted solutions using known or common projection techniques such as those disclosed in WO2022/026121 (PCT International Application no. PCT/US2021/040252) by Applicant and herein incorporated in its entirety. Other projection techniques and methods are suitable.

Returning to FIG. 5, The MISO structures forming the componentized model 200 have respective basis models (architecture) 210, 211, 212 that are connected to system inputs (Input 1 . . . . Input n FIG. 2) based on user-specified input variable/output variable relationships received at step 510. If no input variable/output variable dependencies are specified by the user, then method 500 considers all system inputs (Input 1, . . . . Input n) in each MISO basis model 210, 211, 212. As a function of user-specified system output properties/respective MISO output properties of step 540, method 500 searches basis model library 530 for pertinent basis models to configure respective MISOs of system model 200. At each iteration of steps, method 500 considers for a given MISO only those basis model candidates in basis model library 530 that have the respective user-specified output property, for non-limiting example smooth derivatives, certain non-linearity, and the like functional behavior.

Continuing with method 500, step 533 refers to validation data 531 and validates performance of the selected basis models 210, 211, 212 used to configure the MISOs of system model 200. The validation of the Basis Model performance can be evaluated by some metric (e.g., R\hat{ }2) to meet a minimum threshold (e.g., R\hat{ }2>95% for non-limiting example). However, even the most complex Basis Model may not yield results which satisfy the minimum threshold for a particular MISO. When the tested performance of step 533 is below threshold, method 500 branches at 549 and proceeds to step 547. If a more complex Basis Model candidate in library 530 yields results (even if they do not satisfy the minimum threshold) which are significantly higher than its preceding, less complex Basis Models, then step 547 selects (chooses) the more complex Basis Model candidate for implementation of a respective MISO in system model 200. However, if a more complex Basis Model candidate yields results which are similar to its preceding, less complex Basis Models, then the loop of steps 533, 549, 547, and 515 selects the least complex Basis Model candidate in library 530 which provides the greatest increase in performance for implementation of a respective MISO in system model 200. This assures a lack of redundant complexity within the overall model architecture 110′. The MISO with revised assignment of basis model architecture is trained using training data 520 and reconciliation layer 220 is included in the training, and performance of the now assigned basis models of MISOs is validated at step 533, and so on. In this way, embodiments for each iteration of selecting and revising assignment 547 of a basis model architecture to a MISO assure to not sacrifice explainability for minimal performance increase.

In embodiments, the metrics, thresholds, and significant increase in performance values can be chosen by the user (or otherwise predefined), stored at 531 as validation data, and may vary for each MISO. In circumstances where a user does not wish to choose metrics, thresholds, or increase in performance values for some or all MISOs, method 500 assigns a default value or otherwise defines these constants, parameters, etc. stored as validation data 531.

After method 500 has selected and assigned basis models 210, 211, 212 (as architecture of respective MISOs) that satisfy the performance thresholds at 533 or are at maximum complexity, step 555 outputs system model 200 with componentized neural network architecture 110′ and configured for use in process control, design optimization, plant scheduling, and the like. The resulting system model 200 is formed of the plural MISO models each configured by a respective optimally selected basis model architecture from basis model library 530 given the user-specified constraints and the user-specified properties of system model output/MISO model output. Each MISO model describes and represents a respective input variable/output variable relationship (dependency) of a subset of the input variables and respective associated one output variable of system model 200. Different MISO models represent a different one of the output variables of system model 200. The plural MISO models enable: (a) a stratified distribution of training data and test data for each output variable, and (b) modeling relatively simple input variable/output variable relationships with a minimal number of parameters while modeling other input variable/out variable relationships with relatively complex representation on an as need basis. In this way, embodiments produce improved working models 200 of industrial plant processes/chemical processes, and in particular produce a modular customized neural network (machine learning) model architecture 110′ based on test data and domain knowledge.

As a proof of concept, Applicants utilized the proposed approach to model the behavior of a Fluid Catalytic Cracking (FCC) process based on a simulation dataset. The corresponding data include 12 independent and 53 dependent variables. First, Applicants trained a fully nonlinear neural network model 100 for all of the dependent variables, and the associated outcomes exhibited a high level of predictability. Then, in a second attempt (model 200), Applicants used a combination of linear and nonlinear basis models 210, 211, 212 depending on the complexity of behavior of each dependent variable. For this particular dataset, it turned out that about 70% of the outputs could be modeled linearly (without any hidden layers in the neural network architecture 110′ and using only linear activation functions) yielding R²>99%. The rest of the neural network 110′ outputs were modeled nonlinearly (with only one hidden layer with 8 neurons). Comparing the architecture of these two neural networks 110, 110′ (in models 100, 200 respectively) shows a significant decline (about 63%) in the number of trainable parameters in the latter case (see FIG. 3). Also, the R² scores of the test dataset for all the dependent variables are shown in FIG. 4. It is evident that using a comparatively smaller neural network 110′ and less complex basis models 210, 211, 212, Applicants could still achieve a high level of predictability. It is remarkable that both models 100, 200 exhibit the same performance in terms of satisfying the associated constraints (variable physical bounds and mass balance for non-limiting example).

### Computer Support

Embodiments of the present invention may be applied to models that represent various industrial processes, chemical processes (e.g., pharmaceutical, petroleum processes, etc.), physics-based processes, or physical sciences, and the like. There is a wide range of model areas, for non-limiting example, subsurface engineering, digital grid management, mining applications or domain, and so forth.

For purposes of illustration and not limitation, FIG. 8 provides but one example.

Turning to FIG. 8, illustrated is a process control (or more generally a process modeling, design, and/or simulation) method and system 140 embodying the present invention. Briefly, an industrial plant (chemical processing plant, refinery, or the like), or industrial environment 120 performs chemical processes (generally industrial processes) of interest 124. Non-limiting examples include pharmaceuticals production, petroleum refining, polymer processing, subsurface engineering, digital grid management, mining or related production, and so on. Plant 120 equipment includes distillation columns, various kinds of reactors and reactor tanks, evaporators, pipe systems, valves, heaters, etc. by way of illustration and not limitation. Plant data 102 represents inputs (feed amounts, values of certain variables, etc.) and outputs (products, residuals, physical operating characteristics/conditions, sensor readings, etc.) of the chemical or industrial process 124. A controller 122 employs model process control to configure and maintain settings 132 (i.e., parameter values, temperature selection, pressure settings, flow rate, other values of variables representing physical characteristics) operating the plant equipment or industrial environment in carrying out the subject chemical or industrial process 124.

The model process control is based on models (of the subject chemical or industrial process 124) generated by process modeling system 130. In embodiments of the present invention, the process modeling system 130 generates and deploys improved system models 200 (detailed above) of the subject chemical or industrial process 124 by customizing an initial model 100 (its architecture 110) using multiple MISOs and corresponding machine learning basis models 210, 211, 212 (or more generally neural network basis model architectures) automatically selected from a Basis Model library 530 based on training data and domain knowledge. The improved system model 200 (with customized architecture 110′ having minimized parameterization and complexity) predicts the progress and physical characteristics/conditions of the subject chemical or industrial process 124. The predictions enable improved performance of the subject chemical/industrial process by any of: enabling a process engineer to troubleshoot the chemical/industrial process, enabling debottlenecking of the chemical/industrial process, and optimizing performance of the chemical or industrial process at the industrial plant/industrial environment 120. The model predictions further include indications of any need to update the settings 132 and specific values to quantitatively update the settings 132. FIGS. 1, 2, and 5 further detail the methods and techniques 100, 200, 500 for customizing system models 100, 200 using machine learning models (neural network architecture) 210, 211, 212 to generate Applicant's inventive and advantageous improved models 200 in process modeling, simulation, optimization, and control 140.

In embodiments, controller 122 is one or more application processors, such as a design optimization system, a supply planner, a plant scheduler, an advanced process controller, etc. In a generalized sense, controller 122 is an interface between process modeling system 130 and industrial plant/environment 120. Other interfaces between process modeling system 130 and plant/industrial environment 120 in addition to and/or instead of controller 122 are suitable and in the purview of one skilled in the art given the disclosure herein. For example, there may be an interface between process modeling system 130 and plant 120 systems. There may be a user interface for process modeling system 130. Process modeling system 130 may effectively be part of a simulator or optimizer for non-limiting examples. Various such interfaces enable an end user, e.g., process engineer, to utilize model predictions in (a) monitoring and troubleshooting plant operations and the chemical process of interest 124, in (b) identifying bottlenecks in chemical process 124, and in (c) de-bottlenecking the same, and so forth. In embodiments, an interface enables a process engineer to utilize the model predictions in optimizing (online or offline) the chemical/industrial process 124 at the plant/industrial environment 120. In these and other similar ways, embodiments enable various improvements in performance of the chemical process 124 at the subject plant 120 (or generally improvements in the industrial process 124 in environment 120).

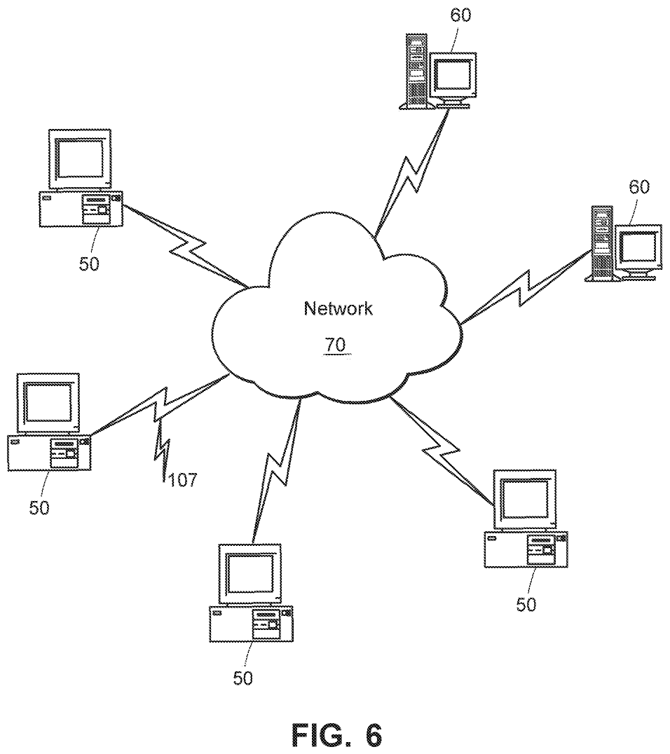

FIG. 6 illustrates a computer network or similar digital processing environment in which embodiments (such as method 500, system/method 140, and the like) of the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), cloud computing servers or service, a worldwide collection of computers, Local area or Wide area networks, and gateways that currently use respective protocols (TCP/IP, Bluetooth, etc.) to communicate with one another. Other electronic device/computer network architectures are suitable.

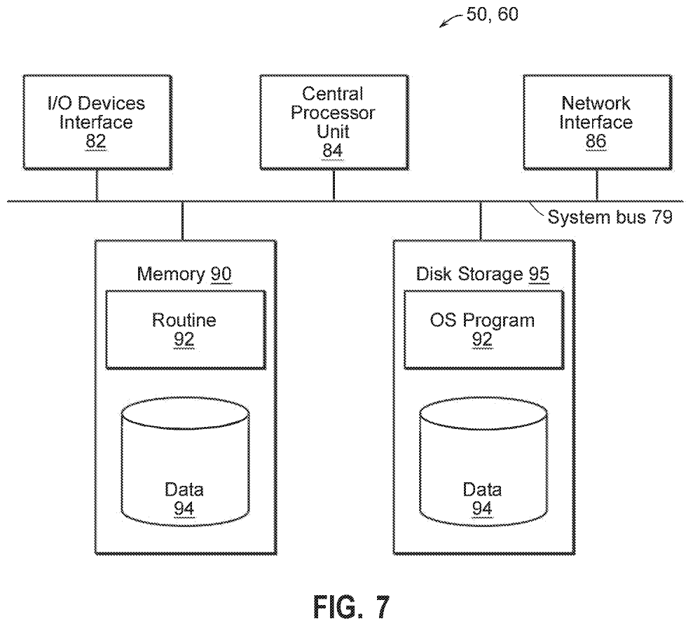

FIG. 7 is a diagram of the internal structure of a computer (e.g., client processor/device 50 or server computers 60) in the computer system of FIG. 6. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 4). Memory 90 provides volatile storage for computer software instructions 92 and data 94 used to implement an embodiment of the present invention (e.g., neural network architectures 110, 110′, MISO components, system models 100, 200, method 500, corresponding techniques (including user interaction), data 520, 531, basis model library 530, and supporting code detailed above). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

In other embodiments, the program product 92 may be implemented as a so-called Software as a Service (SaaS), or other installation or communication supporting end-users.

The teachings of all patents, published applications, and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A computer-implemented method of modeling an industrial or chemical process, comprising:
Obtaining a subject model of an industrial process, the subject model being formed of plural multiple input single output (MISO) models, each MISO model representing a respective input variable-output variable relationship of a subset of input variables and associated one output variable of the subject model, and different MISO models representing a different one of the output variables, wherein the plural MISO models enable modeling relatively simple input variable-output variable relationships with a minimal number of parameters while modeling other input variable-output variable relationships with relatively complex representation on an as need basis;
for each MISO model, automatically assigning a basis model architecture of minimal complexity that enforces the respective input variable-output variable relationship of the MISO model; and
using the plural MISO models with assigned architecture forming a customized machine learning architecture for the subject model, said forming resulting in an improved model of the industrial process.

2. A method as claimed in claim 1 wherein the industrial process is any of: a chemical process, processing of a pharmaceutical, petroleum processing or part thereof, a subsurface engineering process, digital grid management, a mining domain process, and the like.

3. A method as claimed in claim 1 wherein obtaining the subject model includes:
accessing a model of the industrial process, the accessed model having multiple input variables and multiple output variables (MIMO);
splitting the accessed model into the plural MISO models of the subject model.

4. A method as claimed in claim 1 wherein the automatic assigning a basis model architecture includes: (a) initially assigning a linear basis model architecture to each MISO model; and (b) training and evaluating performance of the MISO models, for a MISO model having the respective input variable-output variable relationship performing poorly using the assigned linear basis model architecture, revising assignment to a more complex basis model architecture relative to the linear basis model architecture.

5. A method as claimed in claim 1 wherein a given MISO model has a respective input variable-output variable relationship that is a linear function; and
for the given MISO model, the automatic assigning assigns a basis model architecture that has a linear activation function and thus enforces linear input variable-output variable relationships.

6. A method as claimed in claim 1 wherein a given MISO model has a respective input variable-output variable relationship that is a smooth function; and
for the given MISO model, the automatic assigning assigns a basis model architecture that has a smooth activation function and thus enforces smooth, free of discontinuities input variable-output variable relationships.

7. A method as claimed in claim 1 wherein said automatic assigning is in a manner resulting in minimizing overall number of parameters in the formed customized machine learning architecture; and the steps of obtaining, automatic assigning, and forming are implemented by one or more digital processors.

8. A method as claimed in claim 1 wherein the plural MISO models further enable a stratified distribution of training data and test data for each output variable.

9. A method as claimed in claim 1 further comprising: coupling the plural MISO models with assigned architecture to a reconciliation layer, the reconciliation layer configured to receive: (i) values of the multiple input variables, and (ii) values of the output variables of the plural MISO models, and the reconciliation layer ensuring adherence to constraints of the industrial process.

10. A method as claimed in claim 9 wherein in runtime of the resulting improved model, the reconciliation layer refrains from modifying predictions from a MISO model with assigned basis model architecture that extrapolates well and instead corrects predictions from one or more MISO models with assigned basis model architecture that is unreliable for extrapolation.

11. A method as claimed in claim 1 wherein the automatic assigning a basis model architecture for a given MISO model includes searching a library of basis models for a best basis model architecture for the one output of the given MISO model, the library being held in computer memory; and
wherein the searching of the library is performed in programmed automated fashion by a processor as a function of any one or more of: (a) user-specified input variable-output variable relationships, (b) user-specified constraint of the subject industrial plant process, and (c) user-specified properties for the one output of the given MISO model.

12. A computer-based system comprising:
a computer memory coupled to one or more digital processors; and
a computer program product having computer executable instructions that model industrial or chemical processes, the computer program product being loadable into the computer memory and when executed by at least one of the digital processors implements:
obtaining a subject model of an industrial process, the subject model formed of or being transformed to be formed of plural multiple input single output (MISO) models, each MISO model representing a respective input variable-output variable relationship of a subset of input variables and associated one output variable of the subject model, and different MISO models representing a different one of the output variables, wherein the plural MISO models enable modeling relatively simple input variable-output variable relationships with a minimal number of parameters while modeling other input variable-output variable relationships with relatively complex representation on an as need basis;
for each MISO model, automatically assigning a basis model architecture of minimal complexity that enforces the respective input variable-output variable relationship of the MISO model; and
using the plural MISO models with assigned architecture forming a customized machine learning architecture for the subject model, said forming resulting in an improved model of the industrial process.

13. A computer-based system as claimed in claim 12 wherein the industrial process is any of: a chemical process, processing of a pharmaceutical, petroleum processing or part thereof, a subsurface engineering process, digital grid management, a mining-related process, and the like.

14. A computer-based system as claimed in claim 12 wherein the automatic assigning a basis model architecture includes: (a) initially assigning a linear basis model architecture to each MISO model; and (b) training and evaluating performance of the MISO models, for a MISO model having the respective input variable-output variable relationship performing poorly using the assigned linear basis model architecture, revising assignment to a more complex basis model architecture relative to the linear basis model architecture.

15. A computer-based system as claimed in claim 12 wherein a given MISO model has a respective input variable-output variable relationship that is a linear function; and
for the given MISO model, the automatic assigning assigns a basis model architecture that has a linear activation function and thus enforces linear input variable-output variable relationships.

16. A computer-based system as claimed in claim 12 wherein a given MISO model has a respective input variable-output variable relationship that is a smooth function; and
for the given MISO model, the automatic assigning assigns a basis model architecture that has a smooth activation function and thus enforces smooth, free of discontinuities input variable-output variable relationships.

17. A computer-based system as claimed in claim 12 wherein said automatic assigning is in a manner resulting in minimizing overall number of parameters in the formed customized machine learning architecture.

18. A computer-based system as claimed in claim 12 wherein the plural MISO models further enable a stratified distribution of training data and test data for each output variable.

19. A computer-based system as claimed in claim 12 wherein execution further implements coupling the plural MISO models with assigned architecture to a reconciliation layer, the reconciliation layer configured to receive: (i) values of the multiple input variables, and (ii) values of the output variables of the plural MISO models, and the reconciliation layer ensuring adherence to constraints of the industrial process; and
wherein in runtime of the resulting improved model, the reconciliation layer refrains from modifying predictions from a MISO model with assigned basis model architecture that extrapolates well and instead corrects predictions from one or more MISO models with assigned basis model architecture that is unreliable for extrapolation.

20. A computer-based system as claimed in claim 12 further comprising: a library of basis models, the library accessible to the digital processors, wherein the automatic assigning a basis model architecture for a given MISO model includes a processor searching the library of basis models for a best basis model architecture for the one output of the given MISO model; and
wherein the searching of the library is performed as a function of any one or more of: (a) user-specified input variable-output variable relationships, (b) user-specified constraint of the industrial process, and (c) user-specified properties for the one output of the given MISO model.
